(19) United States
(12) Patent Application Publication
(10) Pub. No.: US 2022/0066295 A1
(43) Pub. Date: Mar. 3, 2022

(54) OPTICAL DEVICE, PROJECTOR, AND IMAGING DEVICE

(71) Applicant: SEIKO EPSON CORPORATION, Tokyo (JP)

(72) Inventor: Eiji MORIKUNI, Matsumoto-shi (JP)

(21) Appl. No.: 17/462,453

(22) Filed: Aug. 31, 2021

(30) Foreign Application Priority Data
Aug. 31, 2020 (JP) 2020-145439

(51) Int. Cl. G03B 21/00; G02B 13/16; G03B 21/28

(52) U.S. Cl. CPC G03B 21/005; G02B 17/08; G03B 21/28; G02B 13/16

(57) ABSTRACT

An optical device includes a plurality of optical elements, a holding member configured to hold the plurality of optical elements, and a partition wall. The first optical element is a lens and disposed in a position closest to an enlargement side out of the plurality of optical elements. The first optical element has an incident surface, a reflecting surface configured to reflect light which enters through the incident surface, and an exit surface configured to emit the light reflected by the reflecting surface. The incident surface and the exit surface are provided to a first surface facing to a reduction side in the first optical element. The partition wall partitions the incident surface and the exit surface.

The present application is based on, and claims priority from JP Application Serial Number 2020-145439, filed Aug. 31, 2020, the disclosure of which is hereby incorporated by reference herein is its entirety.

### BACKGROUND

### 1. Technical Field

The present disclosure relates to an optical device, a projector, and an imaging device.

### 2. Related Art

A projector which projects a projection image formed by an image formation section on a screen with a projection optical system in an enlarged manner is described in JP-A-2020-020860. The projection optical system in that document has a refracting optical system, and a reflecting optical system disposed at an enlargement side of the refracting optical system.

The reflecting optical system is formed of a single lens. Such a lens has an incident surface which a light beam from the refracting optical system enters, a reflecting surface for reflecting the light beam having entered through the incident surface, and an exit surface which emits the light reflected by the reflecting surface. The incident surface and the exit surface are disposed on a first surface facing to a reduction side in the lens. The light beam emitted from the exit surface reaches the screen.

The light beam emitted from the exit surface of the lens reaches the screen. Therefore, it is unachievable to cover the exit surface of the lens with a lens barrel for holding the projection optical system. Therefore, in the lens barrel, there is disposed an opening part for exposing the exit surface of the lens to the outside.

Here, the incident surface and the exit surface are disposed on the same surface of the lens, Therefore, when the opening part for exposing the exit surface to the outside is provided to the lens barrel, it becomes possible to make a visual contact with the incident surface from the opening part. As a result, when a foreign matter such as dust enters the lens barrel via the opening part of the lens barrel, the foreign matter enters a space between the lens and an optical element constituting the reflecting optical system in some cases. When the foreign matter enters in the middle of the projection optical system for projecting the projection image in an enlarged mariner, a shadow of the foreign matter is reflected on the screen in an enlarged manner.

### SUMMARY

In view of the problems described above, an optical device according to the present disclosure includes a plurality of optical elements, a holding member configured to hold the plurality of optical elements, and a partition wall. The first optical element is a lens and disposed in a position closest to the enlargement side out of the plurality of optical elements is a lens. The first optical element has an incident surface, a reflecting surface configured to reflect light which enters through the incident surface, and an exit surface configured to emit the light reflected by the reflecting surface. The incident surface and the exit surface are provided to a first surface facing to a reduction side in the first optical element. The partition wall partitions the incident surface and the exit surface.

### BRIEF DESCRIPTION OF THE DRAWINGS

FIG. 1 is a ray chart schematically showing a whole of an optical device according to Practical Example 1.

FIG. 2 is a ray chart of the optical device according to Practical Example 1.

FIG. 3 is a perspective view of the optical device according to Practical Example 1.

FIG. 4 is a ray chart of an optical device adopting a partition wall according to Modified Example 1.

FIG. 5 is a ray chart of an optical device adopting a partition wall according to Modified Example 2.

FIG. 6 is a schematic configuration diagram of a projector equipped with the optical device.

FIG. 7 is a schematic configuration diagram of an imaging device equipped with the optical device.

FIG. 8 is a ray chart of an optical device according to Practical Example 2.

FIG. 9 is a ray chart of an optical device according to Practical Example 3.

### DESCRIPTION OF AN EXEMPLARY EMBODIMENT

An optical device, a projector, and an imaging device according to an embodiment of the present disclosure will hereinafter be described with reference to the drawings.

### Optical Device

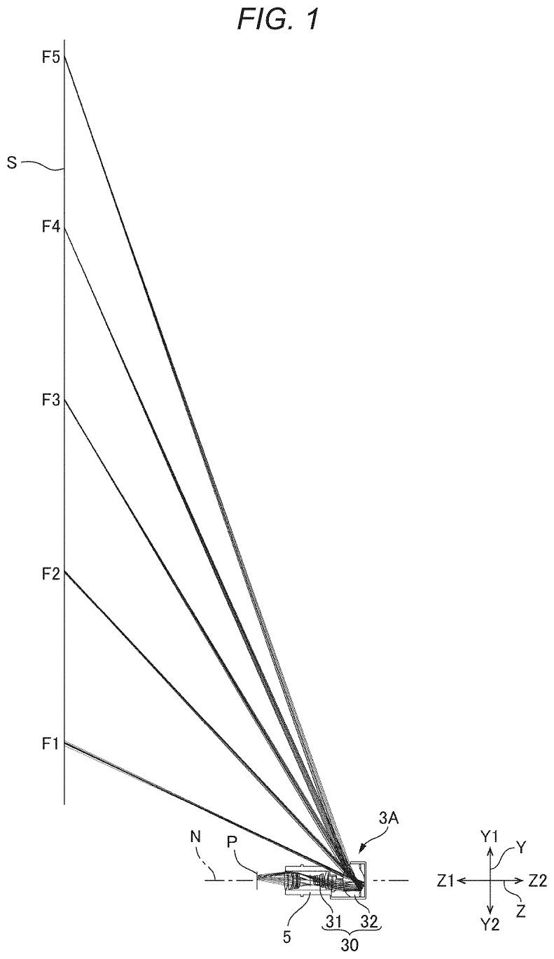

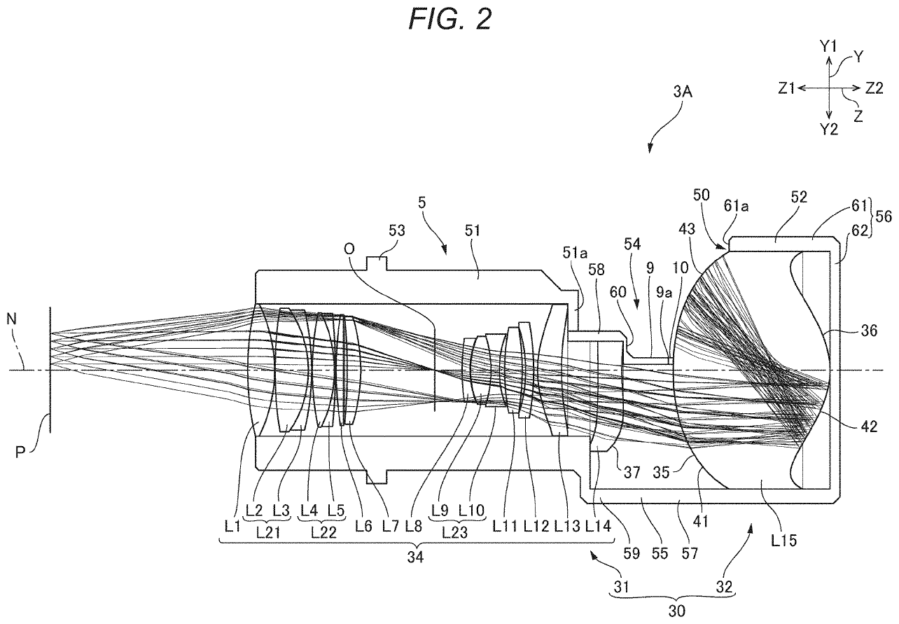

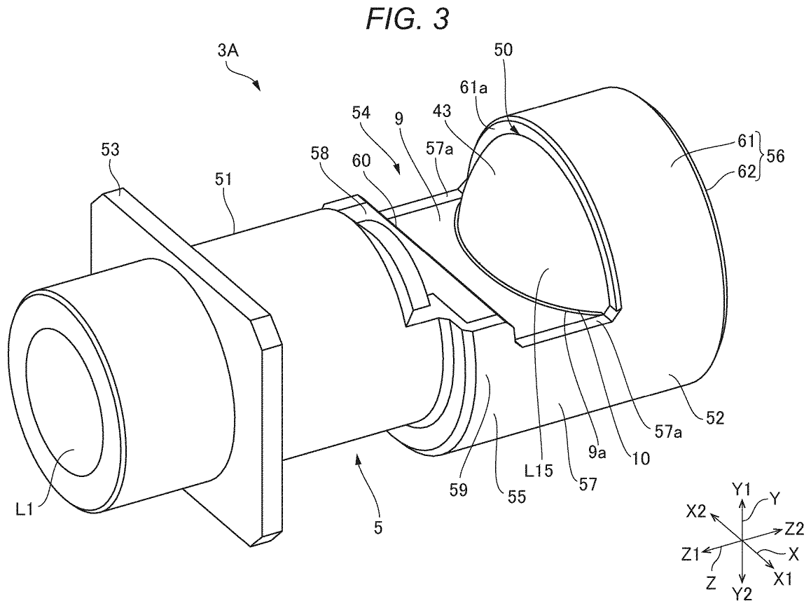

FIG. 1 is a ray chart of a whole of an optical device according to Practical Example 1. FIG. 1 schematically shows light beams which reach an enlargement-side imaging plane S from a reduction-side imaging plane P of the optical device with light fluxes F1 through F5. The light flux F1 is a light flux which reaches a position where the image height is the lowest in the enlargement-side imaging plane S. The light flux F5 is a light flux which reaches a position where the image height is the highest in the enlargement-side imaging plane S. The light flux F2, the light flux F3, and the light flux F4 are light fluxes which reach positions between the positions of the light flux F1 and the light flux F5. FIG. 2 is a ray chart of the optical device according to Practical Example 1. FIG. 3 is a perspective view of the optical device.

As shown in FIG. 1 and FIG. 2, the optical device 3A is provided with an optical system 30 constituted by a plurality of optical elements, and a holding member 5 for holding the optical system 30. The optical system 30 is constituted by a first optical system 31 and a second optical system 32 arranged in this order from a reduction side toward an enlargement side. As shown in FIG. 3, the holding member 5 is a lens barrel. Further, the optical device is provided with a partition wall 9 located between the first optical system 31 and the second optical system 32.

In the following description, three axes perpendicular to each other are defined as an X axis, a Y axis, and a Z axis for the sake of convenience. A Z-axis direction is a direction in which an optical axis N of the first optical system 31 extends. In the Z-axis direction, a side at which the first optical system 31 is located is defined as a first direction Z1, and a side at which the second optical system 32 is located is defined as a second direction Z2. A Y-axis direction corresponds to a vertical direction in FIG. 1. One side in the Y-axis direction is defined as an upper side Y1, and the other side is defined as a lower side Y2. Further, a plane which is perpendicular to the X axis and includes the Y axis and the Z axis is defined as a Y-Z plane. Therefore, FIG. 1 and FIG. 2 show the Y-Z plane. Here, the reduction-side imaging plane P is shifted toward the upper side Y1 of the optical axis N. The enlargement-side imaging plane S is located at the upper side Y1 of the optical device 3A,

### Optical System

As shown in FIG. 2, the first optical system 31 is provided with lenses L1 through L14 in this order from the reduction side toward the enlargement side. A lens group 34 (an optical element group) constituted by these 14 lenses is a refracting optical system. The lens L2 and the lens L3 are bonded to each other to form first cemented lens L21. The lens L4 and the lens L5 are bonded to each other to form a second cemented lens L22. The lens L9 and the lens L10 are bonded to each other to form a third cemented lens L23. An aperture O is disposed between the lens L7 and the lens L8. In the first optical system 31, the lens L14 (a second optical element) closest to the enlargement side is cut out an a portion located at the upper side Y1 of the optical axis N of the first optical system 31. Thus, the lens L14 is provided with a flat portion at the upper end of the outer circumferential surface thereof.

The second optical system 32 is formed of a lens L15 (a first optical element) as a single lens. The lenses are made of glass or resin. In the present example, the lens L15 is made of resin. The lens L15 is provided with a first surface 35 facing to the reduction side, and a second surface 36 facing to an opposite side to the first surface 35. The first surface 35 and the second surface 36 are each provided with a convex shape. Further, at least one of the first surface 35 and the second surface 36 is provided with an aspherical shape. Further, the lens L15 is provided with a reflective coating layer in a lower side portion of the second surface 36. Thus, the lens L15 is provided with a reflecting surface 42 in the second surface 36, wherein the reflecting surface 42 has a concave shape on which the surface shape of the second surface 36 is transferred. Therefore, the second optical system 32 is a reflecting optical system.

The lens L15 is disposed on the optical axis N of the first optical system 31. An optical axis of the lens L15 coincides with the optical axis N of the first optical system 31. Therefore, the second optical system 32 and the first optical system 31 are provided with a single optical system.

Here, the light beam entering the lens L15 from the first surface 35 side is reflected by the reflecting surface 42, and is emitted from the first surface 35. In other words, the lens L15 is provided with an incident surface 41, the reflecting surface 42 for reflecting the light entering through the incident surface 41, and an exit surface 43 for emitting the light reflected by the reflecting surface 42. The incident surface 41 and the exit surface 43 are provided to the first surface 35. The incident surface 41 is located at the lower side Y2 of the optical axis N, and the exit surface 43 is located at the upper side Y1 of the optical axis N. The reflecting surface 42 is located at the lower side of the optical axis N. Therefore, the reflecting surface 42 reflects the light beam from the lower side Y2 of the optical axis N toward the upper side Y1. In the first surface 35, the incident surface 41 and the exit surface 43 do not overlap each other.

### Holding Member

The holding member 5 is made of resin. As shown in FIG. 2 and FIG. 3, the holding member 5 holds the lenses L1 through L15. As shown in FIG. 3, the holding member 5 is provided with a small-diameter lens barrel part 51, and a large-diameter lens barrel part 52 larger in diameter than the small-diameter lens barrel part 51 arranged in this order from the first direction Z1 toward the second direction Z2. The large-diameter lens barrel part 52 and the small-diameter lens barrel part 51 are coaxially disposed. Further, the holding member 5 is provided with a flange part 53 extending toward the outer side in the radial direction disposed in the middle in the Z-axis direction of the small-diameter lens barrel part 51. The flange part 53 has a quadrangular shape when viewed from the Z-axis direction. Further, the holding member 5 is provided with a cutout part 54 disposed at an upper side of an end portion at the small-diameter lens barrel part 51 side of the large-diameter lens barrel part 52.

As shown in FIG. 2 and FIG. 3, the small-diameter lens barrel part 51 holds the lenses L1 through L13 from an outer circumferential side. The large-diameter lens barrel part 52 holds the lens L14 and the lens L15 from an outer circumferential side. The large-diameter lens barrel part 52 is provided with a first holding portion 55 for holding the lens L14, a second holding portion 56 for holding the lens L15, and a coupling plate portion 57 located between the first holding portion 55 and the second holding portion 56. The first holding portion 55 and the coupling plate portion 57 are located at the lower side Y2 of the cutout part 54.

The first holding portion 55 is provided with a plate part 58 making contact with a flat portion of the outer circumferential surface of the lens L14 from above, and a curved plate part 59 for coupling an end at one side in the X-axis direction of the plate part 58 and the other end thereof to each other. The curved plate part 59 is provided with a circular arc shape curved around the optical axis N of the first optical system 31. In other words, the curved plate part 59 is curved from the end at the one side in the X-axis direction of the plate part 58 toward the other side in the X-axis direction toward the lower side Y2, and is then further curved toward the other side in the X-axis direction toward the upper side to be coupled to the end at the other side in the X-axis direction of the plate part 58. The plate part 58 is bridged between an upper end portion at one side of the curved plate part 59 in the X-axis direction and an upper end portion at the other side thereof. Here, a space between an end edge in the second direction Z2 of the small-diameter lens barrel part 51 and an upper surface of the plate part 58 is closed by a blocking plate 51a extending from the end edge in the second direction Z2 of the small-diameter lens barrel part 51 toward an inner circumferential side. Further, the first holding portion 55 is provided with a sidewall part 60 extending from the end edge in the second direction Z2 of the plate part 58 downward along a second surface 37 facing to the second direction Z2 of the lens L14.

The coupling plate portion 57 has a circular arc shape curved around the optical axis N of the first optical system 31. The coupling plate portion 57 has an opening end facing upward. The coupling plate portion 57 couples the curved plate part 59 of the first holding portion 55 and the second holding portion 56 to each other.

The second holding portion 56 is located in the second direction Z2 of the cutout part 54. The second holding portion 56 is provided with a barrel part 61 which surrounds the lens L15 from the outer circumferential side, and a plate part 62 which has a circular shape, and closes the end in the second direction Z2 of the barrel part 61. The barrel part 61 is coaxial with the lens L15. The second surface 36 of the lens L15 has contact with the plate part 62. The first surface 35 of the lens L15 faces to the cutout part 54. The first surface 35 protrudes from an end edge 61a in the first direction Z1 of the barrel part 61 toward the first direction Z1.

### Partition Wall

As shown in FIG. 2 and FIG. 3, the partition wall 9 is disposed at a lower end edge of the sidewall part 60 of the first holding portion 55. The partition wall 9 has a plate-like shape, protrudes from the sidewall part 60 and extends in the Z-axis direction between the lens L14 and the lens L15. Further, the partition wall 9 extends along upper end edges 57a of the coupling plate portion 57. One end in the X-axis direction of the partition wall 9 is continuous with the upper end edge 57a at one side in the X-axis direction of the coupling plate portion 57, and the other end in the X-axis direction of the partition wall 9 is continuous with the upper end edge 57a at the other side in the X-axis direction of the coupling plate portion 57. Thus, the partition wall 9 closes the coupling plate portion 57 from above.

Here, as shown in FIG. 3, when viewed from the Y-axis direction, an end edge 9a in the second direction Z2 of the Partition wall 9 is provided with a concave shape along the first surface 35 of the lens L15. The partition wall 9 partitions the first surface 35 of the lens L15 into the incident surface 41 and the exit surface 43 at slightly upper side Y1 of the optical axis N of the first optical system 31. In the present example, a buffer member 10 intervenes between the partition wall 9 and the first surface 35. The buffer member 10 is formed of rubber or urethane. The buffer member 10 is disposed between the end part of the partition wall 9 in the second direction Z2 and the first surface 35 of the lens 115, and is pressed by the partition wall 9 against the first surface 35 to thereby be fixed. It should be noted that it is possible for the buffer member 10 to be fixed to the end part in the second direction Z2 of the partition wall 9, or the first surface 35 of the lens L15 with an adhesive.

When the coupling plate portion 57 is closed by the partition wall 9 from the upper side Y1, the holding member 5 is provided with an opening part 50 disposed in an upper side portion, wherein only the exit surface 43 of the lens L15 is exposed to the outside by the opening part 50. The opening part 50 is zoned by the partition wall 9, the buffer member 10, and an end edge 61a of the barrel part 61 of the second holding portion 56.

### Functions and Advantages

The optical device 3A according to the present example is provided with the plurality of optical elements, the holding member 5 for holding the plurality of optical elements, and the partition wall 9. The first optical element disposed in a position closest to the enlargement side out of the plurality of optical elements is the lens L15. The lens L15 has the incident surface 41 which the light enters, the reflecting surface 42 for reflecting the light entering through the incident surface 41, and the exit surface 43 for emitting the light reflected by the reflecting surface 42. The incident surface 41 and the exit surface 43 are disposed on the first surface 35 facing to a reduction side in the lens L15. The partition wall 9 partitions the incident surface 41 and the exit surface 43.

According to the present example, the optical device 3A is provided with the partition wall 9 for partitioning the incident surface 41 and the exit surface 43 provided to the first surface 35 of the lens L15. Therefore, even when the holding member 5 for holding the optical system is provided with the opening part 50 for exposing the exit surface 43 of the lens L15 to the outside, it is possible to prevent the incident surface 41 of the lens L15 from being exposed to the outside from the opening part 50. Therefore, it is possible to prevent or suppress that a foreign matter enters the reduction side of the lens L15. Therefore, it is possible to prevent or avoid the phenomenon that the shadow of the foreign matter is reflected on the screen in an enlarged manner. In particular, the incident surface 41 is disposed at a position close to an intermediate image formed inside the lens L15, and when the foreign matter such as dust adheres to the incident surface 41, an image corresponding to the foreign matter is formed on the projection surface disposed on the enlargement-side imaging plane S, and thus, there is a possibility that the image quality deteriorates. However, the deterioration of the image quality can be prevented by the present example, and therefore, the present example is particularly advantageous in the optical element having at least one reflecting surface inside such as the lens L15 in the present embodiment.

In the present example, the partition wall 9 is provided to the holding member 5. Therefore, it is easy to provide the partition wall 9 to the optical device 3A.

Further, in the present example, the buffer member 10 intervenes between the partition wall 9 and the first surface 35. Therefore, it is possible to prevent the partition wall 9 and the first surface 35 of the lens L15 from making contact with each other to damage the first surface 35. Further, when the buffer member 10 intervenes between the partition wall 9 and the lens L15, even when a gap between the partition wall 9 and the lens L15 varies due to a vibration caused by dropping and so on, it is possible to absorb such a variation with the buffer member 10. Therefore, it is possible to prevent the first surface 35 from being damaged due to the vibration caused by the dropping and so on.

Then, the second surface 36 of the lens L15 is provided with the convex shape. Further, the lens L15 is provided with the reflective coating layer in the second surface 36. The reflecting surface 42 is the reflective coating layer, and is provided with the concave shape on which the surface shape of the second surface 36 is transferred. In the present example, since the reflecting surface 42 is provided with the concave shape, it is easy to set the enlargement ratio of the optical system high.

Further, the light beam from the first optical system 31 proceeds via the incident surface 41, the reflecting surface 42, and the exit surface 43. Therefore, it is possible to further increase the enlargement ratio of the optical system using these surfaces. Further, it is possible to prevent an aberration in the enlargement-side imaging plane S from occurring using these surfaces.

In the present example, the optical axis N of the first optical system 31 and the optical axis of the second optical system 32 are the same. Therefore, the plurality of lenses L1 through L15 is provided with the single optical axis. Therefore, it possible to accurately arrange the lenses L1 through L15.

In the present example, the incident surface 41 is located at the lower side Y2 of the optical axis N, and the exit surface 43 is located at the upper side Y1 of the optical axis N. Therefore, it is easy to provide the incident surface 41 and the exit surface 43 to the first surface 35 of the lens L15.

### Modified Examples

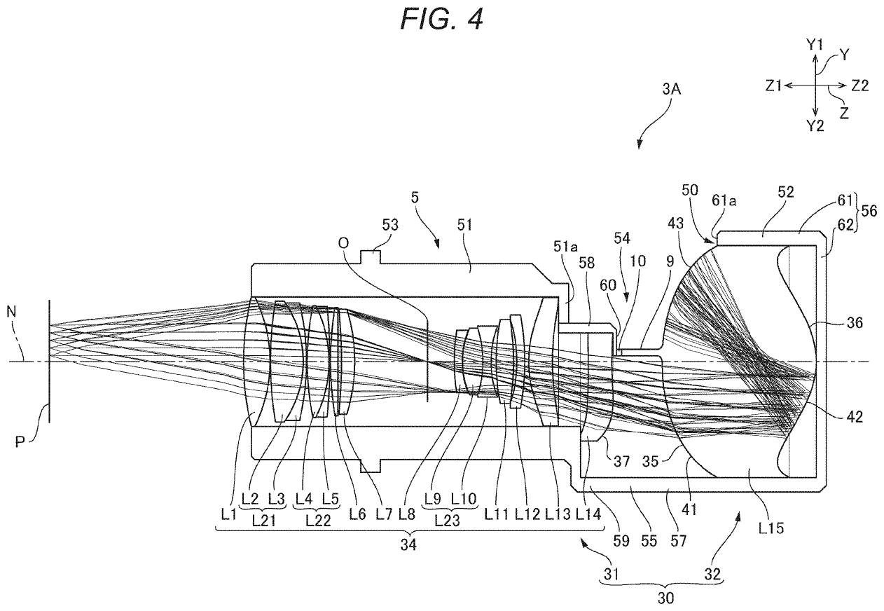

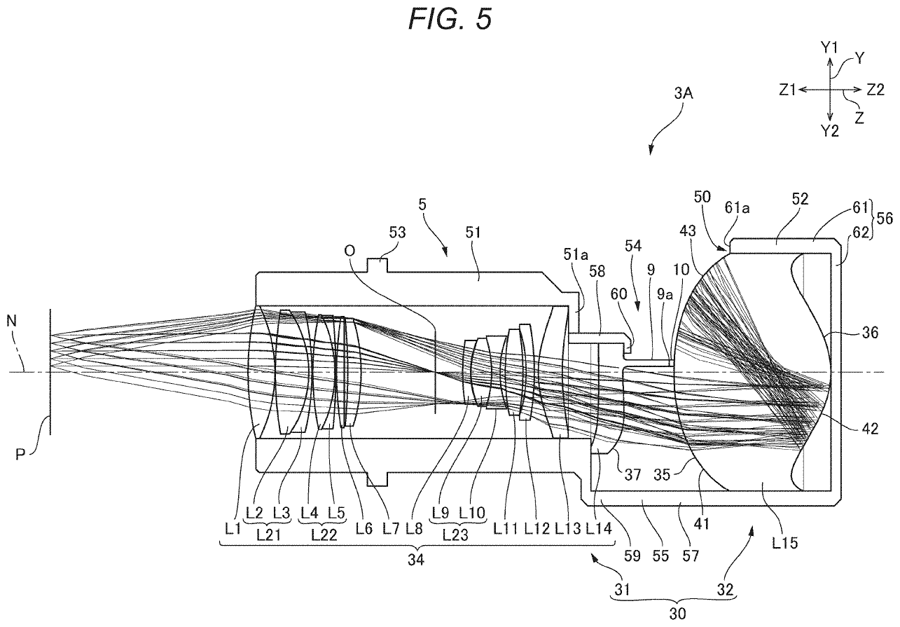

FIG. 4 is an explanatory diagram of the optical device 3A according to Modified Example 1. FIG. 5 is an explanatory diagram of the optical device 3A according to Modified Example 2. The optical device 3A according to Modified Example 1 and the optical device 3A according to Modified Example 2 are different in configuration of the optical device 3A and the partition wall 9 from each other, but are the same in other configurations as each other. Therefore, in the description of the optical device 3A according to Modified Example 1 and the optical device 3A according co Modified Example 2, the configurations corresponding to those of the optical device described above are denoted by the same reference symbols, and the description thereof will be omitted.

As shown in FIG. 4, in the optical device 3A according to Modified Example 1, the partition wall 9 is disposed on the first surface 35 of the lens L15. More specifically, the partition wall 9 has a plate-like shape, and protrudes toward the first direction Z1 from slightly upper side of the optical axis of the first optical system 31 in the first surface 35. The partition wall 9 is located between the second surface 37 of the lens L14 and the lens L15 in the Z-axis direction. Thus, the partition wall 9 partitions the incident surface 41 and the exit surface 43. Further, the partition wall 9 extends along an upper end edge 57a of the coupling plate portion 57 to close the coupling plate portion 57 from above. An end in the first direction Z1 of the partition wall 9 is opposed to the sidewall part 60 of the first holding portion 55 for holding the lens L14. In the present example, the buffer member 10 intervene s between the partition wall 9 and the sidewall part 60 of the first holding portion 55.

When the coupling plate portion 57 is closed by the partition wall 9 from above, the holding member 5 is provided with the opening part 50 disposed in an upper surface thereof, wherein only the exit surface 43 of the lens L15 s exposed to the outside by the opening part 50. The opening part 50 is zoned by the partition wall 9 and the end edge 61a in the first direction Z1 of the barrel part 61 of the second holding portion 56.

Also in the present example, the optical device 3A is provided with the partition wall 9 for partitioning the incident surface 41 and the exit surface 43 provided to the first surface 35 of the lens L15. Therefore, even when the holding member 5 for holding the optical system is provided with the opening part 50 for exposing the exit surface 43 of the lens L15 to the outside, it is possible to prevent, the incident surface 41 of the lens L15 from being exposed to the outside from the opening part 50. Therefore, it is possible to prevent or suppress that a foreign matter enters the reduction side of the lens L15. Therefore, it is possible to prevent or avoid the phenomenon that the shadow of the foreign matter is reflected on the screen in an enlarged manner.

Further, in the present example, the lens L15 and the partition wall 9 are integrally formed of resin. Therefore, positional accuracy of the partition wall 9 to the first surface 35 is high. Therefore, it is possible to accurately partition the incident surface 41 and the exit surface 43 with the partition wall 9. Further, in the present example, since the lens L15 and the partition wall 9 are integrally formed of resin, there is no chance for a foreign matter to enter the incident surface 41 through a space between the partition wall 9 and the lens L15.

As shown in FIG. 5, in the optical device 3A according to Modified Example 2, the partition wall 9 is provided to the lens L14 located adjacent to the lens L15. More specifically, the partition wall 9 has a plate-like shape, and protrudes toward the second direction Z2 from slightly upper side Y1 or the optical axis N of the first optical system 31 in the second surface 37 at the enlargement side of the lens L14. The partition wall 9 is located between the second surface 37 or the lens L14 and the lens L15. Further, the partition wall 9 is located between the incident surface 41 and the exit surface 43 provided to the first surface 35 of the lens L15 in the Z-axis direction. Thus, the partition wall 9 partitions the incident surface 41 and the exit surface 43 provided to the first surface 35 of the lens L15. Further, the partition wall 9 extends along an upper end edge 57a of the coupling plate portion 57 to close the coupling plate portion 57 from above. The buffer member 10 intervenes between the partition wall 9 and the first surface 35 of the lens L15.

When the coupling plate portion 57 is closed by the partition wall 9 from above, the holding member 5 is provided with the opening part 50 disposed in an upper surface thereof, wherein only the exit surface 43 of the lens L15 is exposed to the outside by the opening part 50. The opening part 50 is zoned by the partition wall 9, the buffer member 10, and the end edge 61a in the first direction Z1 of the barrel part 61 of the second holding portion 56.

Also in the present example, the optical device 3A is provided with the partition wall 9 for partitioning the incident surface 41 and the exit surface 43 provided to the first surface 35 of the lens L15, Therefore, even when the holding member 5 for holding the optical system is provided with the opening part 50 for exposing the exit surface 43 of the lens L15 to the outside, it is possible to prevent the incident surface 41 of the lens L15 from being exposed to the outside from the opening part 50. Therefore, it is possible to prevent or suppress that a foreign matter enters the reduction side of the lens L15. Therefore, it is possible to prevent or avoid the phenomenon that the shadow of the foreign matter is reflected on the screen in an enlarged manner.

### Projector

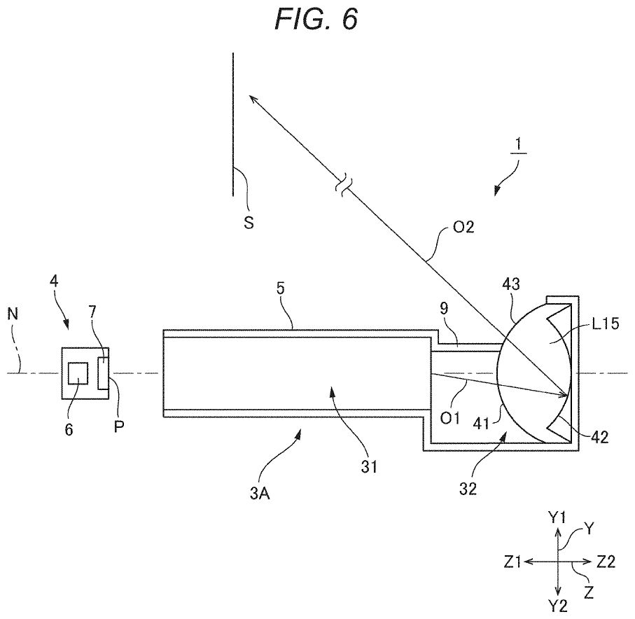

FIG. 6 is an explanatory diagram of a projector 1 equipped with the optical device 3A according to the present example. As shown in FIG. 6, the projector 1 is provided with an image formation section 4 for forming a projection image on the reduction-side imaging plane P of the optical device 3A. The image formation section 4 is provided with a light source 6 and a light modulator 7 for modulating the light beam from the light source 6. The light modulator 7 is, for example, a liquid crystal panel. The light modulator 7 modulates the light beam from the light source 6 based on an image signal for forming the projection image. The projection image formed on the reduction-side imaging plane is projected on a screen disposed on the enlargement-side imaging plane S of the optical device 3A. It should be noted that the reduction-side imaging plane P in the projector 1 is disposed substantially at the center of the optical axis N, but this is not a limitation, and the reduction-side imaging plane P can be disposed at one side with respect to the optical axis N, or can be disposed at the other side with respect to the optical axis N.

In the present example, the light modulator 7 forms the projection image at the upper side Y1 of the optical axis N of the first optical system 31. A light beam O1 from the light modulator 7 enters the incident surface 41 of the lens L15 located at the lower side Y2 of the optical axis via the first optical system 31. The light beam O1 having entered the incident surface 41 s folded back by the reflecting surface 42 located at the lower side Y2 of the optical axis N. The light beam O2 having been folded by the reflecting surface 42 is emitted from the exit surface 43 located at the upper side Y1 of the optical axis N to reach the screen disposed at the upper side Y1 of the optical device 3A.

### Imaging Device

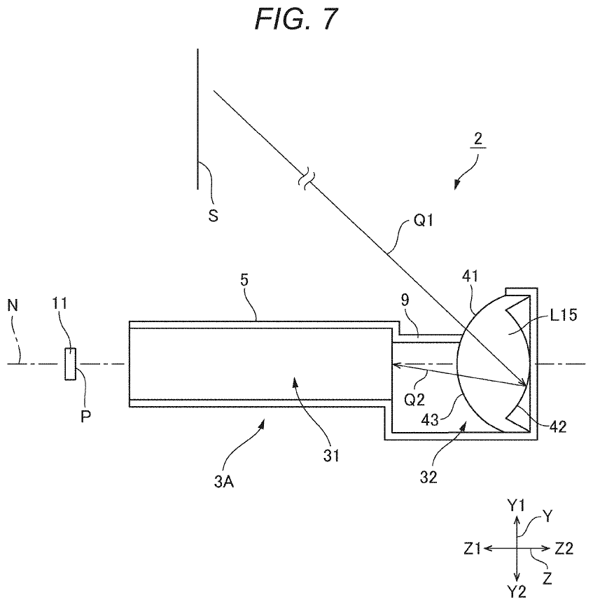

FIG. 7 is an explanatory diagram of an imaging device 2 provided to the optical device 3A according to the present example. In the imaging device 2, an imager 11 is disposed on the reduction-side imaging plane P of the optical device 3A. In this case, the light beam Q1 from the enlargement-side imaging plane S enters the incident surface 41 located at the upper side Y1 of the optical axis N in the first surface 35 of the lens L15. The light beam having entered the incident surface 41 is folded back by the reflecting surface 42 located at the lower side Y2 of the optical axis N. The light beam Q2 folded back by the reflecting surface 42 is emitted from the exit surface 43 located at the lower side of the optical axis N to proceed toward the first optical system 31. The light beam having entered the first optical system 31 is imaged on the imager 11 disposed on the reduction-side imaging plane P. It should be rioted that the reduction-side imaging plane P in the imaging device 2 is not limited to being disposed substantially at the center of the optical axis N, but can also be disposed at one side with respect to the optical axis N, or can also be disposed at the other side with respect to the optical axis N similarly to the projector 1 shown in FIG. 6.

Practical Example 2

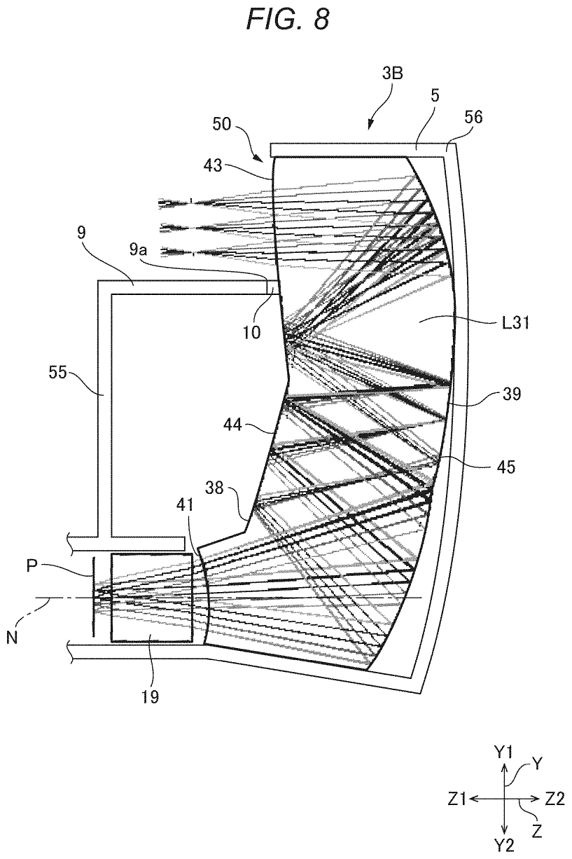

FIG. 8 is a ray chart of an optical device 3B according to Practical Example 2. It should be noted that the optical device 3B according to the present example is provided with constituents corresponding to those of the optical device 3A described above. Therefore, the corresponding constituents are denoted by the same reference symbols, and the description thereof will be omitted. As shown in FIG. 8, the optical device 3B according to the present example is provided with a first optical element and a second optical element. Further, the optical device 3B is provided with the holding member 5 for holding he first optical element and the second optical element, and the partition wall 9.

The first optical element is a lens L31 provided with a first surface 38 and a second surface 39 facing to an opposite side to the first surface 38. The second optical element is a cross dichroic prism 19. The lens L31 is elongated in a direction crossing the optical axis N between the reduction-side imaging plane P and the cross dichroic prism 19. The cross dichroic prism 19 is opposed to a lower end portion of the lens L31.

The lens L31 is provided with the incident surface 41 disposed in the lower end portion of the first surface 38, wherein the light beam from the second optical element enters the incident surface 41. Further, the lens L31 is provided with the exit surface 43 in an upper end portion of the first surface 38. Further, the lens L31 is provided with a first reflective coating layer disposed between the incident surface 41 and the exit surface 43 of the first surface 38. Therefore, the lens is provided with a first reflecting surface 44 disposed between the incident surface 41 and the exit surface 43 of the first surface 38. Further, the lens L31 is provided with the reflective coating layer in the second surface 39. Thus, the lens L31 is provided with a second reflecting surface 45 in the second surface 39. Here, the light beam which has entered the incident surface 41 of the lens L31 from the reduction-side imaging plane P via the cross dichroic prism 19 is folded back a plurality of times between the second reflecting surface 45 and the first reflecting surface 44, and is then emitted from the exit surface 43.

Here, the holding member 5 is provided with the first holding portion 55 for holding the cross dichroic prism 19, and the second holding portion 56 for holding the lens L31. The partition wall 9 has a plate-like shape, and protrudes from the first holding portion 55 toward the lens L31 to partition the first surface 38 of the lens L31 into the incident surface 41 and the exit surface 43. In the present example, the partition wall 9 is disposed at a position closer to the exit surface 43 than to the incident surface 41.

Also in the present example, the optical device 38 is provided with the partition wall 9 for partitioning the incident surface 41 and the exit surface 43 provided to the first surface 38 of the lens L31. Therefore, even when the holding member 5 for holding the optical system is provided with the opening part 50 for exposing the exit surface 43 of the lens L31 to the outside, it is possible to prevent the incident surface 41 of the lens L31 from being exposed to the outside from the opening part 50. Therefore, it is possible to prevent or suppress that a foreign matter enters the reduction side of the lens L31. Therefore, it is possible to prevent or avoid the phenomenon that the shadow of the foreign matter is reflected on the screen in an enlarged manner.

It should be noted that the partition wall 9 can be disposed on the first surface 38 of the lens L31 integrally with the lens L31.

### Practical Example 3

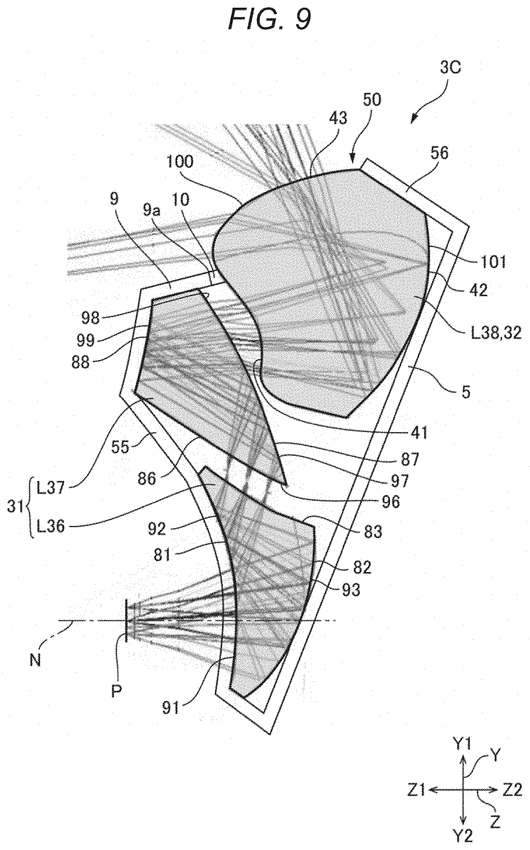

FIG. 9 is a ray chart of an optical device 3C according to Practical Example 3. It should be noted that the optical device 3C according to the present example is provided with constituents corresponding to those of the optical device 3A described above. Therefore, the corresponding constituents are denoted by the same reference symbols, and the description thereof will be omitted. As shown in FIG. 9, the optical device 3C according to the present example is provided with the first optical system 31 and the second optical system 32 in this order from the reduction side toward the enlargement side. Further, the optical device 3C is provided with the holding member 5 for holding the first optical system 31 and the second optical system 32, and the partition wall 9.

The first optical system 31 is provided with a lens L36 and the lens L37 (the second optical element). The lens L36 and the lens L37 are arranged in a direction crossing the optical axis N between the reduction-side imaging plane P and the lens L36. It should be noted that the second optical system 32 is disposed at an opposite side to the reduction-side imaging plane P with respect to the lens L37.

The lens L36 is provided with a first surface 81 facing to the reduction-side imaging plane P, a second surface 82 facing to an opposite side to the first surface 81, and a third surface 83 facing to the opposite side to the first surface 81 at the lens L37 side of the second surface 82. The lens L36 is provided with an incident surface 91 disposed in a portion opposed to the reduction-side imaging plane P of the first surface 81. Further, the lens L36 is provided with a first reflective coating layer disposed at a side closer to the third surface 83 than to the incident surface 91 in the first surface 81. Therefore, the lens L36 is provided with the incident surface 91 and a first reflecting surface 92 in the first surface 81. Further, the lens L36 is provided with the reflective coating layer in the second surface 82. Thus, the lens L36 is provided with a second reflecting surface 93 in the second surface 82. Here, the light beam which has entered the incident surface 91 of the lens L36 from the reduction-side imaging plane P is folded back by the second reflecting surface 93 and the first reflecting surface 92, and is then emitted from the third surface 83. In other words, the third surface 83 is the exit surface. The light beam emitted from the third surface 83 proceeds toward an incident surface 96 of the lens L37.

The lens L37 is provided with a first surface 86 facing to the lens L36, a second surface 87 opposed to the first surface 86 and facing to the second optical system 32, and a third surface 88 opposed to the second surface 87 and facing to an opposite side to the second optical system 32. Further, the lens L37 is provided with a first reflective coating layer disposed at a side closer to the lens L36 in the second surface 87. Therefore, the lens L37 is provided with a first reflecting surface 97 at a side closer to the lens L36 in the second surface 87. Further, the lens L37 is provided with an exit surface 98 adjacent to the first reflecting surface 97 in the second surface 87. Further, the lens L37 is provided with a reflective coating layer in the third surface 88. Thus, the lens L37 is provided with a second reflecting surface 99 in the third surface 88. The first surface 86 is the incident surface 96 which the light beam from the lens L36 enters. The light beam having entered The lens L37 from the incident surface 96 is folded back by the first reflecting surface 97 and the second reflecting surface 99, and is then emitted from the exit surface 98. The light beam emitted from the exit surface 98 proceeds toward the second optical system 32.

The second optical system 32 is formed of a lens L38 (the first optical element) as a single lens. The lens L38 is made of glass or resin in the present example, the lens L38 is made of resin. The lens L38 is provided with a first surface 100 facing to the reduction side, and a second surface 101 facing to an opposite side to the first surface 100. Further, the lens L38 is provided with a reflective coating layer disposed at a side closer to the first optical system 31 of the second surface 101. Thus, the lens L38 is provided with the reflecting surface 42 in the second surface 101, wherein the reflecting surface 42 has a concave shape on which the surface shape of the second surface 101 is transferred.

Here, the light beam entering the lens L38 from the first surface 100 side from the lens L37 is reflected by the reflecting surface 42, and is emitted from the first surface 100. In other words, the lens L38 is provided with the incident surface 41, the reflecting surface 42 for reflecting the light entering through the incident surface 41, and the exit surface 43 for emitting the light reflected by the reflecting surface 42. The incident surface 41 and the exit surface 43 are provided to the first surface 100. The incident surface 41 is located at a side closer to the lens L37 in the first surface 100, and the exit surface 43 as located at a side farther from the lens L37 in the first surface 100. The reflecting surface 42 is located at a side closer to the lens L37 in the second surface 101. In the first surface 100, the incident surface 41 and the exit surface 43 do not overlap each other.

Here, the holding member 5 is provided with the first holding portion 55 for holding the lens L36 and the lens L37, and the second holding portion 56 for holding the lens L38. The partition wall 9 has a plate-like shape, and protrudes from the first holding portion 55 toward the lens L38 to partition the first surface 100 of the lens L38 into the incident surface 41 and the exit surface 43.

Also in the present example, the optical device 3C is provided with the partition wall 9 for partitioning the incident surface 41 and the exit surface 43 provided to the first surface 100 of the lens L38. Therefore, even when the holding member 5 for holding the optical system is provided with the opening part 50 for exposing the exit surface 43 of the lens L38 to the outside, it is possible to prevent the incident surface 41 of the lens L38 from being exposed to the outside from the opening part 50. Therefore, it is possible to prevent or suppress that a foreign matter enters the reduction side of the lens L38. Therefore, it is possible to prevent or avoid the phenomenon that the shadow of the foreign matter is reflected on the screen in an enlarged manner.

It should be noted that the partition wall 9 can be disposed on the first surface 100 of the lens L38 integrally with the lens L38. Further, the partition wall 9 can be disposed integrally with the lens L37.

What is claimed is:

1. An optical device comprising:
a plurality of optical elements;
a holding member configured to hold the plurality of optical elements; and
a partition wall, wherein
a first optical element is a lens, the first optical element being disposed in a position closest to an enlargement side out of the plurality of optical elements,
the first optical element has an incident surface, a reflecting surface configured to reflect light which enters through the incident surface, and an exit surface configured to emit the light reflected by the reflecting surface,
the incident surface and the exit surface are provided to a first surface facing to a reduction side in the first optical element, and
the partition wall partitions the incident surface and the exit surface.

2. The optical device according to claim 1, wherein
the partition wall is provided to the holding member.

3. The optical device according to claim 1, wherein
the partition wall is provided to a second optical element disposed adjacent to the first optical element out of the plurality of optical elements,

4. The optical device according to claim 1, wherein
the partition wall is provided to the first surface.

5. The optical device according to claim 1, further comprising:
a buffer member disposed between the partition wall and the first surface.

6. The optical device according to claim 1, wherein
a second surface facing to an opposite side to the first surface in the first optical element has a convex shape,
the second surface is provided with a reflective coating layer as the reflecting surface, and
the reflective coating layer has a concave shape on which a surface shape of the second surface is transferred.

7. The optical device according to claim 1, wherein
an optical element group constituted by optical elements located at the reduction side of the first optical element out of the plurality of optical elements is a refracting optical system.

8. The optical device according to claim 1, wherein
the plurality of optical elements has a single optical axis.

9. The optical device according to claim 8, wherein
the incident surface is located at one side of the optical axis, and
the exit surface is located at another side of the optical axis.

10. A projector comprising:
a light modulator configured to modulate light emitted from a light source; and
the optical device according to claim 1 configured to project the light modulated by the light modulator.

11. An imaging device comprising:
the optical device according to claim 1; and
an imager disposed on a reduction-side imaging plane on which light emitted from the optical device is imaged.
